(19) United States
(12) Patent Application Publication
(10) Pub. No.: US 2015/0002654 A1
(43) Pub. Date: Jan. 1, 2015

(54) METHODS AND DEVICES FOR PRESENTING A MATERIAL STRESS ANALYSIS THROUGH CAPTURED IR IMAGES

(71) Applicant: FLIR Systems AB, Taby (SE)

(72) Inventors: Pierre Bremond, Croissy Beaubourg (FR); Emmanuel Vanneau, Paris (FR)

(21) Appl. No.: 14/315,191

(22) Filed: Jun. 25, 2014

Related U.S. Application Data
(60) Provisional application No. 61/839,788, filed on Jun. 26, 2013.

(51) Int. Cl. G06T 7/00; H04N 5/33; H04N 5/30; H04N 7/18

(52) U.S. Cl. CPC G06T 7/0004; H04N 7/18; H04N 5/33; H04N 5/30
USPC 348/86

(57) ABSTRACT

Methods, devices, and systems are provided for presenting a material stress analysis based on infrared (IR), or thermal, images of a real world scene. A method may include receiving multiple consecutively captured IR images as a series of IR frames, wherein the series of IR frames are captured within a time window, obtaining a lock-in signal corresponding to said time window, generating a stress image based on the obtained lock-in signal and the received series of frames, and performing an operation on said stress image.

### CROSS-REFERENCE TO RELATED APPLICATIONS

This application claims the benefit of U.S. Provisional Patent Application No. 61/839,788 filed Jun. 26, 2013 and entitled “METHODS AND DEVICES FOR PRESENTING A MATERIAL STRESS ANALYSIS THROUGH CAPTURED IR IMAGES” which is hereby incorporated by reference in its entirety.

### TECHNICAL FIELD

Generally, embodiments of the invention relate to the technical field of generating a material stress analysis based on infrared (IR), or thermal, images comprising IR image data values of an observed real world scene.

More specifically, different embodiments of the application relate to a thermal or infrared (IR) imaging device generating a material stress analysis based on a lock-in signal and a series of captured IR images which are processed to generate a stress image for display.

### BACKGROUND

Thermal, or infrared (IR), images of scenes are often useful for monitoring, inspection and/or maintenance purposes. Typically, a thermal imaging device, e.g., in the form of a thermography arrangement or an infrared IR camera, is provided to capture an infrared (IR) image comprising infrared (IR) image data values, representing infrared radiation emitted from an observed real world scene. Optionally, visual light (VL) image data values, representing VL emitted or reflected from said observed real world scene, is captured substantially simultaneously with the IR image.

The captured IR image can, after capturing, be displayed on a display, either in a thermal imaging device or in a computing device, such as a tablet computer, a laptop or a desktop computer. The captured IR image can, after capturing, be stored in either a thermal imaging device, an external memory, or a computing device, and subjected to subsequent analysis in order to, for example, detect stressed parts and components of objects in an observed real world scene based on temperature deviations in successive IR images, i.e. multiple IR images captured sequentially in time.

Thermal imaging based on captured IR images has proven to be a successful and high performance means to obtain a stress analysis of an object in an observed real world scene. The stress analysis is useful to localize and quantify local stresses within said object, e.g., construction structures or functional parts of an object under inspection, in particular a high stress concentration zone such as a fatigue crack tip.

Conventional systems often comprise an infrared camera and a lock-in signal source, which connect to a computer performing stress analysis functionality, e.g. running a stress analysis software program. Such systems are powerful, but are difficult to set up and move in between different geographical locations.

Another problem with conventional systems is difficulties in synchronizing an IR camera to a lock-in signal that describes load or stress applied to said observed object. As such, conventional systems are usually working in asynchronous mode, i.e., the frequency of said lock-in signal describing load or stress applied to said observed object is not synchronized to instances when said IR images are captured. Since stress analysis based on captured IR images is dependent on temperature variations, e.g., between the minimum stress applied to an object and the maximum stress applied to an object, the accuracy of the stress analysis is reduced when the capturing of IR images is not synchronized to the lock-in signal.

Thus, for conventional systems today, stress analysis based on IR images is typically performed by external computers and complex software packages, where the analyst often is a high skilled engineer and researcher. There is, therefore, a need for a system that provides increased accuracy and other improvements while reducing complexity in order to enhance the user experience with regard to viewing and analyzing stressed parts and components of an object in an observed real world scene, e.g., of a building or functional parts of an apparatus.

### SUMMARY

Systems and methods are disclosed, in accordance with one or more embodiments, which are directed to providing an enhanced user experience, increased accuracy, and/or other improvements with regard to viewing and analyzing stressed parts and components.

According to one or more embodiments of the invention in the form of systems and methods disclosed herein, a method of generating a material stress analysis image may be performed based on a lock-in signal and a series of consecutively captured infrared (IR) images, wherein the IR images represent infrared radiation emitted from an observed real world scene. The method comprises: capturing IR images in the form of image data values; receiving multiple consecutively captured IR images as a series of IR frames, wherein the series of IR frames are captured within a time window; obtaining a lock-in signal corresponding to said time window; generating a stress image based on the obtained lock-in signal and the received series of frames; and performing an operation on said stress image.

According to another embodiment, the method of generating a material stress analysis image may be performed, wherein the performing the operation comprises sending a display signal to trigger displaying of said generated stress or at least one IR frame of the received series of IR frames on a display comprised in said thermal imaging device.

According to another embodiment, the method of generating a material stress analysis image may be performed, wherein the performing the operation comprises sending the generated stress image as a signal frame of stress image data values to an external processor/processing unit via a communication interface.

According to another embodiment, the method of generating a material stress analysis image may be performed, wherein the generating the stress image further comprises transforming the received series of IR frames to the frequency domain.

According to another embodiment, the method of generating a material stress analysis image may be performed, wherein the transforming the received series of IR frames to the frequency domain comprises performing a Fast Fourier Transform (FFT) on said received series of IR frames.

According to another embodiment, the method of generating a material stress analysis image may be performed, wherein the obtaining the lock-in signal further comprises obtaining phase information of said obtained lock-in signal, and wherein generating the stress image is based on the phase information of said obtained lock-in signal and said received series of frames.

According to another embodiment, the method of generating a material stress analysis image may be performed, wherein the obtaining the lock-in signal comprises receiving said lock-in signal from an external source via a communications interface.

According to another embodiment, the method of generating a material stress analysis image may be performed, wherein the obtaining said lock-in signal comprises performing image processing based on said received series of IR frames.

According to another embodiment, the method of generating a material stress analysis image may be performed, wherein the performing the image processing comprises determining a reference IR image from said series of IR frames.

According to another embodiment, the method of generating a material stress analysis image may be performed, wherein said time window is defined as between a time of capturing the first IR image in said series of IR frames and a time of capturing the last IR image in said series of IR frames.

According to one or more embodiments, a thermal imaging device is provided that may be configured to generate a material stress analysis image based on a lock-in signal and a series of consecutively captured infrared (IR) images, wherein the IR images represent IR radiation emitted from an observed real world scene. The thermal imaging device comprises: an IR imaging system configured to capture a series of IR images; a processor/processing unit; at least one memory; and a communications interface configured to send or receive signals representing data values or parameters to/from the processor/processing unit to/from external units, wherein said processor/processing unit is adapted to control the thermal imaging device to perform the methods of generating a material stress analysis image described above.

According to one or more embodiments, a method of displaying a stress image may be performed using a processor/processing unit comprised in a computing device. The method comprises: receiving a stress image as a signal frame of stress image data values via a communication interface, e.g., from the processor/processing unit of various embodiments of the thermal imaging device discussed above; and sending a display signal to a display to trigger displaying of said received stress image.

According to one or more embodiments, a computing device configured to display a stress image may be provided. The device comprises: a processor/processing unit; a user input device configured to receive input or indications from a user; a display configured to receive a display signal from said processor/processing unit and to display the received display signal as a displayed image; a memory configured to store data values or parameters received from the processor/processing unit or to retrieve and send data values or parameters to the processor/processing unit; a communications interface configured to send or receive data values or parameters to/from the processor/processing unit to/from external units, such as the various embodiments of said thermal imaging device discussed above, wherein said processor/processing unit is adapted to perform the method of displaying a stress image described above.

According to one or more embodiments, a non-transitory computer-readable medium may be provided, wherein the computer-readable medium stores instructions which, when executed by a to processor/processing unit, controls the processor/processing unit to perform any of the methods of generating a material stress analysis image or the methods of displaying a stress image described above.

According to one or more embodiments, a computer program product may be provided that comprises code portions adapted to control a processor to perform any of the methods of generating a material stress analysis image or the methods of displaying a stress image described above.

The scope of the invention is defined by the claims, which are incorporated into this Summary by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF DRAWINGS

FIG. 1 shows a schematic view of a thermography arrangement for inspecting of material parts under stress by enabling a stress analysis and interpretation of infrared (IR) image data in an IR image depicting a real world scene, in accordance with an embodiment of the disclosure.

FIG. 2 shows a schematic view of a thermography arrangement for obtaining, processing, and storing IR data to an IR image, in accordance with an embodiment of the disclosure.

FIG. 3 illustrates a pre-determined relationship describing a mapping from infrared image data values to the pre-defined palette, in accordance with an embodiment of the disclosure.

FIG. 4 shows a flowchart of a method to generate a material stress analysis image based on a lock-in signal and a series of consecutively captured IR images

FIG. 5 shows a flowchart of a method to display a stress image using processor/processing unit comprised in a computing device, in accordance with an embodiment of the disclosure.

FIG. 6 shows an example method of use according to an embodiment of the disclosure wherein multiple IR images are captured, a lock-in signal is obtained, a stress image is generated and operations are performed on captured IR images or generated stress images.

FIG. 7 shows an example method of use according to an embodiment of the disclosure wherein a generated stress image or captured IR image is sent to an external computing device, e.g., for display on the external computing device.

Embodiments of the invention and their advantages are best understood by referring to the detailed description that follows. It should be appreciated that like reference numerals are used to identify like elements illustrated in one or more of the figures.

### DETAILED DESCRIPTION

### Introduction

### Capturing

Thermal imaging devices, such as thermography arrangements or IR cameras comprising an IR imaging system, are often used in various applications such as surveillance and inspection or monitoring of various objects (e.g., buildings) to capture IR image data values that represent infrared radiation emitted from an observed real world scene. As known in the art, IR cameras with an IR imaging system generally employ a lens working with a corresponding infrared IR detector to provide an image of a view of an observed real world scene. The operation of such cameras is generally as follows. Infrared energy is accepted via infrared optics, including the lens, and directed onto the IR detector elements. Each detector element responds to the infrared radiation or heat energy received. A frame of IR image data values may, for example, be captured by scanning all the rows and columns of a detector and, in some embodiments, analog to digital converted to obtain a captured IR image wherein IR image data values associated with each detector element is referred to as an IR image pixel in the IR image, having an associated row and column index.

### Calibration

Certain characteristics of IR radiation sensors cause measurement errors. Individual detector elements have unique response characteristics. These response characteristics are found to produce non-uniformities, which result in noise. Additionally, heat generated internally by the thermal imaging device and the environment surrounding the thermal imaging device causes temperature drifts which cause offsets in the captured infrared data compared with infrared data emitted from the observed real world scene. Many infrared cameras have functionality to correct for such non-uniformities and temperature drifts. Such functionality may be referred to herein as IR temperature calibration. For example, some infrared cameras can automatically or manually perform offset compensation/IR temperature calibration, which corrects for such non-uniformities and temperature drifts by observing a uniform IR or thermal scene. More specifically for one example, performing non-uniformity and/or temperature drift correction may include placing a shutter between the optics and the detector elements, measuring offset correction data for each detector element which provides the desired uniform output response, and obtaining a reading of the surrounding environment (e.g., measuring the ambient temperature). These measured non-uniformities offset corrections values and temperature drift offset correction values, herein referred to as IR temperature calibration data parameters, may be stored and later applied in subsequent infrared measurements, when analyzing or interpreting the IR image data values (also referred to as IR image values) to correct for the measurement errors described above.

### Visual Light Imaging System

In one or more embodiments said thermal imaging device, such as thermography arrangements or IR cameras comprising an IR imaging system, further comprises a visual light imaging system configured to capture visual light (VL) image data values that represent VL emitted or reflected from said observed real world scene. The VL image data values may be captured substantially simultaneously with said IR image.

### Lock-in Signal

Measuring stress based on captured infrared images is based on so-called thermo elastic effect, i.e., temperature changes in stressed objects due to adiabatic elastic deformation or the thermodynamic relationship between the change of stress in a under elastic loading and the corresponding change of temperature. A signal (e.g., analog or digital signal) describing or indicating load or stress applied to or otherwise present in an object may be referred to as a lock-in signal. For example, a lock-in signal may have a periodic wave (e.g., including sinusoidal wave) form, random wave form, square wave form, and/or any other wave form representing the load or stress applied to an object. In various embodiments of the disclosure, a lock-in signal associated with an object in an observed real world scene may be obtained and used to synchronize the capturing of IR images. In one example, IR images may be captured, selected, extracted, or otherwise obtained at moments corresponding to when the load or stress exerted on or otherwise present in the observed object is at its minimum and maximum. In another non-limiting example, IR images may be obtained at four or more equidistant phase positions in a lock-in signal period, which can meet the Nyquist sampling rate since at least two samples for each phase component (in-phase and out-of-phase or quadrature component) are obtained.

In one example, the lock-in signal may be obtained from an external sensor. In another example, the captured IR images of the observed object may be processed to extract, derive, or otherwise determine a lock-in signal.

IR images may then be synchronized with the lock-in signal, for example, by synchronizing the capturing with the lock-in signal, by selecting and extracting appropriate (e.g., captured at minimum and maximum stress time points) IR image frames based on the lock-in signal, or by otherwise obtaining appropriate IR image frames according to the lock-in signal. The synchronized IR image can then be used to generate a stress based on the equation describing said thermo elastic effect as would be understood by one skilled in the art. The stress image may include, for example, stress pixels indicative of stress levels, either absolute stress levels or phase stress levels indicative of the change of stress between a first captured IR image and a second captured IR image. The absolute stress levels may be converted into absolute stress units such as MPa or PSI if desired for particular applications. The phase stress levels might be converted into degrees or radians.

### Display Images

According to various embodiments of the disclosure, the captured IR image may be displayed to an intended user based on the captured IR image comprising IR image data values, IR temperature calibration parameters, a predefined palette representing a finite set of grayscale or color values of a color model displayable on a display, and/or a pre-determined relationship describing a mapping from infrared image data values to said pre-defined palette. The stress images, captured IR images, captured VL images, and/or combined IR/VL images may, after capturing or generation, be displayed on a display of either the thermal imaging device or a computing device such as a tablet computer, a laptop or a desktop computer, in order to allow a user to analyze the result. As thermal images by nature are generally low contrast and noisy, the captured IR image may be subjected to various imaging processing in to improve the interpretability of the image before displaying it to a user. Examples of such image processing may include correction with IR temperature calibration parameters, low pass filtering, registration of multiple consecutively captured IR images as a series of IR frames and averaging to obtain an averaged IR image, and/or other suitable IR image processing operation.

As infrared radiation is not visible to the human eye, there is no natural relationship between the captured IR image data values of each pixel in an IR image and a greyscale/colors displayed on a display. Therefore, an information visualization process referred to as false color or pseudo color is used to map captured IR image data values of each IR image pixel in an IR image to a palette used to present the corresponding pixel displayed on a display, e.g., using a palette representing a greyscale or colors. A palette is typically a finite set of color or greyscale representations selected from a color model for the display of images. That is, a pre-defined palette represents a finite set of grayscale or color values of a color model displayable on a display, thereby making the IR image map to the pre-defined palette visible to the human eye. Mapping of captured IR image data values of each pixel in an IR image to a palette used to present the corresponding pixel displayed on a display is typically performed by applying a pre-determined relationship, wherein said pre-determined relationship describes a mapping from infrared image data values to said pre-defined palette.

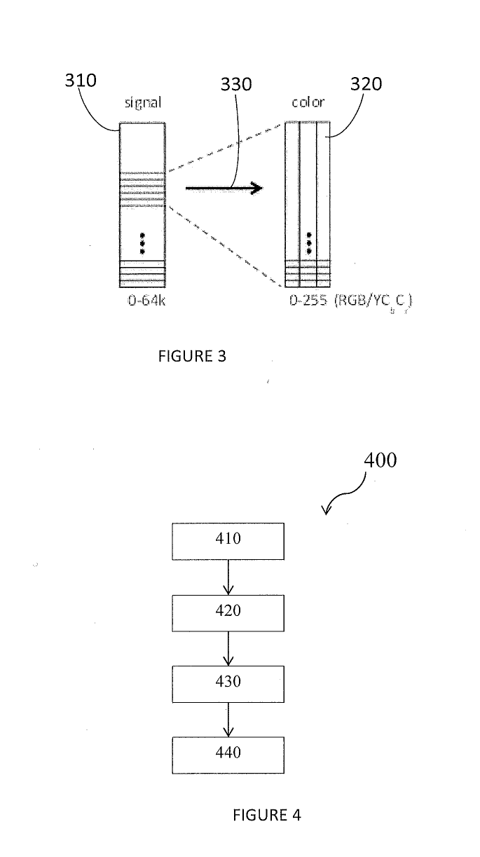

FIG. 3 shows an example of a pre-determined relationship describing a mapping from infrared image data values to said pre-defined palette, according to an embodiment of the disclosure.

### Analyzing

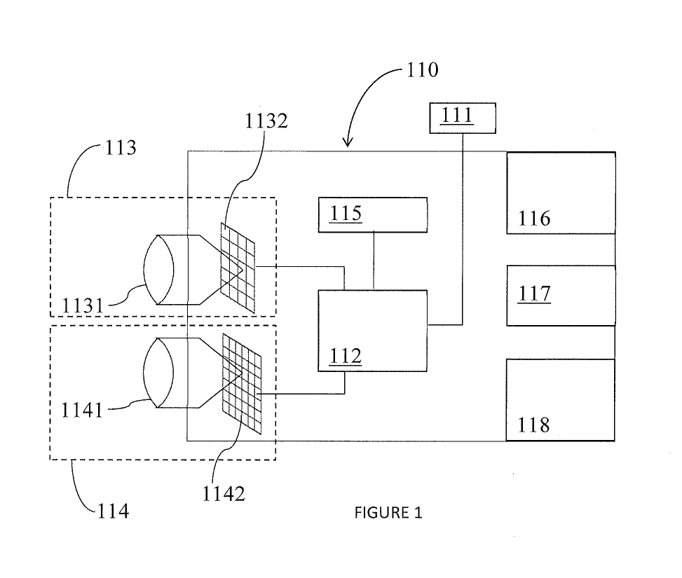

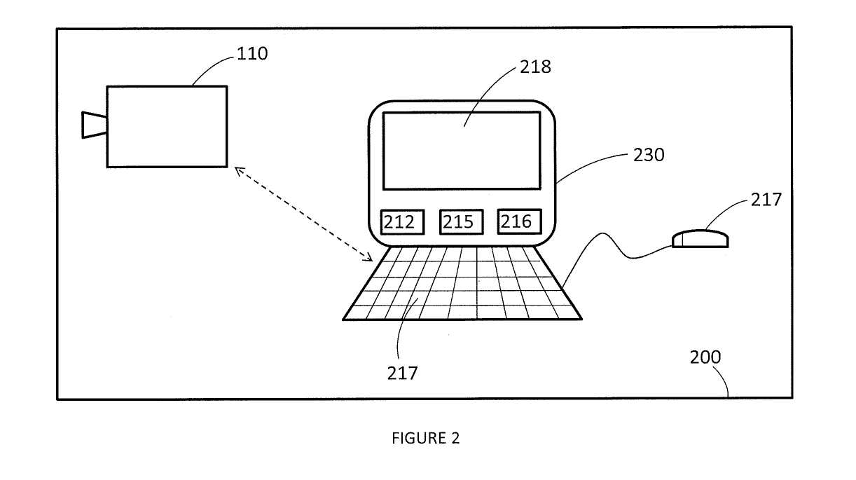

Analyzing stress in an object in an observed real world scene may be described with reference to FIGS. 1 and 2. To analyze stress in an object in an observed real world scene, multiple consecutively captured IR images of the real world scene, as a series of IR frames within a time window, may be received by a processor/processing unit 112. Further, a lock-in signal corresponding to said time window may be obtained either from an external source via a communications interface 116 or by performing image processing on said captured series of IR frames by said processor/processing unit 112. A stress image comprising stress image pixels may be generated based on the lock-in signal and the received series of IR frames by said processor/processing unit 112.

The stress image may include, for example, stress pixels indicative of stress levels, either absolute stress levels or phase to stress levels. The absolute stress levels may be converted into absolute stress level units such as MPa or PSI if desired for particular applications. The phase stress levels might be converted into phase stress level units such as degrees or radians. The stress levels may be divided into real (Re) and imaginary (Im) parts, the absolute stress levels may be calculated as sqrt(Re²+Im²) and the phase stress levels may be calculated as ATAN(Re/im), wherein ATAN is the arctangent functions as would be understood by one skilled in the art.

In addition, an operation on said stress image may be performed. For example, an operation to present said stress image in said thermal device 110 may be performed. In another example, an operation may be performed to send a generated stress image as a signal frame of stress image data values to an external processor/processing unit 212 in a computing device 230 (e.g., a tablet computer, a laptop, PDA, smartphone, mobile phone, cellular communications device, or a desktop computer) via an communication interface 116, wherein said external processor/processing unit 212 may be further arranged to receive (e.g., from processor/processing unit 112) said stress image as a signal frame of stress image data values via an communication interface 216, and to send a display signal to trigger displaying of said received stress image on a display 218.

### System Architecture

FIG. 1 shows a schematic view of a thermal imaging device 110 configured to capture, by an IR imaging system 113 comprised in said thermal imaging device 110, infrared (IR) images in the form of image data values that represent infrared radiation emitted from an observed real world scene, and to generate a material stress analysis based on a lock-in signal and a series of consecutively captured IR images, in accordance with one or more embodiments of the disclosure. In various embodiments, thermal image device 110 may be in the form of, for example, a thermography arrangement or an infrared IR camera.

Said IR imaging system 113 may comprise an IR optical system 1131, e.g., comprising a lens, zoom functionality, and focus functionality, together with a corresponding infrared IR detector 1132, for example, comprising a micro-bolometer focal plane array, arranged to provide an IR image in the form of a signal frame of IR image data values that represent infrared radiation emitted from an observed real world scene. The thermal imaging device 110 may further comprise a processor/processing unit 112 provided with specifically designed programming or program code portions adapted to control the processing unit to perform one or more embodiments of the inventive method described herein. The IR imaging system 113 may be further configured to send the signal frame of IR image data values to processor/processing unit 112. The thermal imaging device 110 further comprises at least one memory 115 configured to store data values or parameters received as a control signal from processor/processing unit 112, or to retrieve and send data values or parameters as a control signal to processor/processing unit 112. The thermal imaging device 110 may further comprise a communications interface 116 configured to send or receive control signals representing data values or parameters to/from processor/processing unit 112 from/to external units.

In one or more embodiments, said communications interface 116 may be configured to receive a lock-in signal that describes or indicates load or stress applied to or otherwise present in an object in said observer real world scene. Said lock-in signal may be analog or digital, depending on embodiments. In one or more embodiments, said communications interface 116 may include a wired communications interface. In such embodiments, the lock-in signal may be received via a wired connection or network. In one or more embodiments, said communications interface 116 may alternatively or additionally include a wireless communications interface. In such embodiments, the lock-in signal may additionally or alternatively be received wirelessly. In one or more embodiments, said external unit may be a computing device, for example computing device 230 shown in FIG. 2.

In one non-limiting example, said communications interface 116 may conform to one or more of GSM, General Packet Radio Service (GPRS), Enhanced Digital GSM Evolution (EDGE), Evolution of GSM (E-GSM). Code Division Multiple Access (CDMA), Wideband Code Division Multiple Access (WCDMA or W-CDMA), Orthogonal Frequency Division Multiple Access (OFDM), Time Division Multiple Access (TDMA), IEEE 802.xx, Digital European Cordless Telecommunication (DECT), Infrared (IR), Wireless Fidelity (Wi-Fi™), Bluetooth™, and other standardized as well as non-standardized systems.

In one non-limiting example, said communications interface 116 may be configured to receive the lock-in signal using voltage input or current input.

In one or more embodiments, said IR imaging system 113 comprised in said thermal imaging device 110 may be configured to capture a series of consecutive IR images as a stream of IR images with a given frame rate or a multiple consecutively captured IR images as a series of IR frames. According to various embodiments, an example operation of thermal imaging device 110, such as an IR camera, may generally be as follows: Infrared energy is accepted via said infrared optical system 1131 and directed onto the IR detector elements 1132. Each detector element responds to the infrared radiation or heat energy received. A frame of IR image data values may, for example, be captured by scanning all the rows and columns of the detector and, in some embodiments, an analog-to-digital conversion may be performed to obtain a captured IR image, wherein data values associated to each detector element may be referred to as an IR image pixel of said IR image and have an associated row and column index.

In one or more embodiments, the thermal imaging device 110 further comprises a visual light (VL) imaging system 114 configured to capture VL image data values that represents VL emitted from an observed real world scene. Said VL imaging system 114 may include a VL optical system 1141 together with a corresponding VL detector 1142. VL optical system 1141 may include, for example, a lens, zoom functionality, and focus functionality, and VL detector 1142 may include, for example, a digital charge-coupled device (CCD) or complementary metal-oxide-semiconductor (CMOS) active pixel sensors, to provide an VL image in the form of a signal frame of VL image data values that represent VL emitted from an observed real world scene.

In one or more embodiments, the VL imaging system 114 may be further arranged to send the signal frame of VL image data values to processor/processing unit 112. In one or more embodiments, the thermal imaging device 110 may further comprise a display 118 configured to receive a signal from processor/processing unit 112 and to display the received signal as a displayed image with displayed pixels mapped to IR image pixels in an IR image based on a palette. In one non-limiting example, the displayed image is displayed to a user of the thermal imaging device 110. In one or more embodiments, the thermal imaging device 110 may be further configured to correct or calibrate the captured IR image data to values by applying pre-determined IR temperature calibration parameters, and/or to align and scale the captured IR image data values for display as an IR (e.g., thermal) image, singly or combined with a VL image.

In one or more embodiments, the thermal imaging device 110 may further comprise an input device 117 configured to receive input or indications from a user, e.g., to indicate a local area of interest in an IR image. In one or more embodiments, the thermal imaging device 110 may further comprise an extended functionality unit 111 configured to add additional emitting or sensor functionality. Said extended functionality unit 111 may be integrated in said thermal imaging device 110, or mechanically attachable/detachable to/from said thermal imaging device 110, as desired for particular applications. If attachably/detachably provided, said extended functionality unit 111 may be configured to communicatively couple to said processor/processing unit 112 when attached. In one or more exemplary embodiments, said extended functionality unit 111 may be one or more of a laser projector, a laser point projector, a visual light searchlight/spotlight, an IR searchlight/spotlight, a temperature sensor, a humidity sensor, a gas sensor, a VL light sensor, and an IR light sensor.

Said thermal imaging device 110 may be adapted to be a handheld type thermal imaging device 110 or a fixed mounted monitoring type thermal imaging device 110, as desired for particular applications. In one or more embodiments, the thermal imaging device 110 may be implemented as one device integrating both the IR imaging system 113 and the VL imaging system 114. In other embodiments, the thermal imaging device 110 may be implemented as two physically separate devices, with a first device comprising a IR imaging system 113 and a second device comprising a VL imaging system 114, communicatively coupled and depicting, or capturing, substantially the same observed real world scene. A memory 115 may be integrated into either one of the first or second device, or memory 115 may be integrated in a physically separate memory device, not shown in the figure, to which said first and second device may be communicatively coupled.

In one or more embodiments, the IR imaging system 113 comprised in the thermal imaging device 110 may be further arranged to send the signal frame of IR image data values or generated stress images to processor/processing unit 112 for intermediate storing in memory 115 comprised in, or separate from (not shown in FIG. 1), the thermal imaging device 110. In one or more embodiments, the IR imaging system 113 comprised in the thermal imaging device 110 may be further arranged to send the signal frame of IR image data values to an external processor/processing unit (not shown in FIG. 1) from said memory 115 via said communications interface 116. In one or more embodiments, the processor/processing unit 112 comprised in the thermal imaging device 110 may be further arranged to send the received IR image as a signal frame of IR image data values to the external processor/processing unit directly or from said memory 115 via said communications interface 116. In one example, said external processor/processing unit may be an external processor/processing 212 unit in computing device 230 of FIG. 2.

In one or more embodiments, the processor/processing unit 112 may be a processor such as a general or specific purpose processor/processing unit. For example, the processor/processing unit 112 may be implemented with a microprocessor, microcontroller, or other control logic that comprises sections of code or code portions, stored in a computer readable storage medium, such as memory 115. Such code or code portions may include a portion that to is fixed for performing certain tasks, but may also include other alterable sections of code that can be altered during use. Such alterable sections of code can comprise parameters that are to be used as input for various tasks, such as the calibration of the thermal imaging device 110, adaption of the sample rate, spatial filtering of the images, or operations that may utilize parameters. In one or more embodiments, the processor/processing unit 112 may be configurable using a hardware description language (HDL).

In one or more embodiments the processor/processing unit 112 may include a programmable logic device (PLD) such as a field-programmable gate array (FPGA). In general, PLDs such as FPGAs may include an integrated circuit designed to be configured by the customer or designer after manufacturing, and as such may be configurable using a HDL. In such embodiments, the thermal imaging device 110 may include (e.g., in memory 115) configuration data, which may be loaded into the FPGA (e.g., serially read into look-up tables (LUTs) of the FPGA) to configured and control the FPGA to perform the various method embodiments described herein.

In this document, the terms “computer program product” and “computer-readable storage medium” may be used generally to refer to media such as a memory 115/215, or the storage medium of processing unit 112/212, or an external storage medium. These and other forms of computer-readable storage media may be used to provide instructions to processing unit 112/212 for execution. Such instructions, generally referred to as “computer program code” (which may be grouped in the form of computer programs or other groupings), when executed, may enable the thermal imaging device 110 to perform features or functions of the various embodiments of the present disclosure. Further, as used herein, “logic” may include hardware, software, firmware, or a combination of thereof.

With reference also to FIG. 2, in one or more embodiments, the processor/processing unit 112/212 may be communicatively coupled to and communicate with memory 115/215 where parameters are kept ready for use by the processing unit 112/212, and where the images being processed by the processing unit 112/212 can be stored if the user desires. The one or more memories 115/215 may comprise a hard RAM, disk drive, a floppy disk drive, a magnetic tape drive, an optical disk drive, a CD or DVD drive (R or RW), and/or other removable or fixed media drive.

FIG. 2 is a schematic view of a thermal imaging system 200 according to one or more embodiments of the invention, wherein the processor/processing unit 112 comprised in the thermal imaging device 110 is further arranged to send a generated stress image as a signal frame of stress image data values to the external processor/processing unit 212 via communication interface 116. In one or more embodiments, said external processor/processing unit 212 may be comprised in a computing device 230 such as a tablet computer, a laptop, PDA, smartphone, mobile phone, cellular communications device or a desktop computer. Said external processor/processing unit 212 may be further arranged to receive said stress image as a signal frame of stress image data values via an communication interface 216 (e.g., from processor/processing unit 112).

The external processor/processing unit 212 may be provided with specifically designed programming or program code portions adapted to control the processing unit to perform various embodiments of the methods described further herein. The computing device 230 further comprises a user input device 217 configured to receive input or indications from a user and a display 218 configured to receive a display signal from said external processor/processing unit 212 and to display the received display signal as a displayed image, e.g., to a user of the computing device 230. The computing device 230 further comprises at least one memory 215 configured to store data values or parameters received from the processor/processing unit 212, or to retrieve and send data values or parameters to the processor/processing unit 212. The computing device 230 may further comprise a communications interface 216 configured to send or receive data values or parameters to/from a processor 212 to/from external units, such as said thermal imaging device 110, via the communications interface 216.

In one or more embodiments, the display 218 may be integrated with a user input device 217 configured to receive input or indications from a user, e.g., by applying touch screen functionality and to send a user input signal to said processor/processing unit 212, as would be understood by one skilled in the art. In one or more embodiments, the user input device 217 comprised or communicatively coupled to said computing device 230 may be configured to receive input or indications from a user by applying eye tracking techniques as would be understood by one skilled in the art. In one or more embodiments, the user input device may be configured to enable control functionality of the computing device 230 and/or the thermal imaging device 110. In one non limiting example, such control functionality might comprise activating or deactivating capturing of IR images or capturing of VL images, updating parameters, controlling focus, zoom functionality, or other functionality as desired for particular applications of the computing device 230 and/or the thermal imaging device 110.

### Method Embodiments

FIG. 4 is a flowchart of a method 400 to generate a material stress analysis image based on a lock-in signal and a series of consecutively captured IR images using a processor/processing unit comprised in a thermal imaging device, in accordance with an embodiment of the disclosure. For example, the method 400 may be performed using the processor/processing unit 112 comprised in the thermal imaging device 110 configured to capture infrared (IR) images in the form of IR image data values that represents infrared radiation emitted from an observed real world scene. In general, one or more embodiments of method 400 may comprise various operations as follows.

At block 410, multiple consecutively captured IR images may be received as a series of IR frames. According to various embodiments, the series of IR frames may be captured within a time window as further described herein. In one or more embodiments, wherein said time window is defined as between the time of capturing the first IR image in said series of IR frames and the time of capturing the last IR image in said series of IR frames.

At block 420, a lock-in signal corresponding to said time window may be obtained. For example, the lock-in signal may be obtained in any of the various ways described above under the heading “Lock-in Signal.” In one or more embodiments, obtaining the lock-in signal may involve determining or otherwise obtaining phase information of the lock-in signal in manners that would be understood by one skilled in the art. In one or more embodiments, the lock-in signal may be obtained by receiving it from an external source via a communications interface 116, in manners that would be understood by one skilled in the art. In one or more embodiments, image processing operations may be performed on said received series of IR frames to extract, determine, or otherwise obtain the lock-in signal. In one specific example, the image processing operations may involve determining a reference IR image from said series of IR frames.

At block 430, a stress image comprising stress image pixels may be generated based on the lock-in signal and the received series of IR frames. In one or more embodiments, generating the stress image may include transforming the received series of IR frames to the frequency domain, in manners that would be understood by one skilled in the art. In one example, transforming the received series of IR frames to the frequency domain may include performing a Fast Fourier Transform (FFT) on said received series of IR frames.

In one or more embodiments, said stress pixels are indicative of stress levels, either absolute stress levels or phase stress levels. In one or more embodiments, the absolute stress levels may be converted into absolute stress level units such as MPa or PSI if desired for particular applications. In one or more embodiments, the phase stress levels might be converted into phase stress level units such as degrees or radians. In one or more embodiments, the stress levels may be divided into real (Re) and imaginary (Im) parts, the absolute stress levels may be calculated as sqrt(Re²+Im²) and the phase stress levels may be calculated as ATAN(Re/Im), wherein sqrt is the square root function and ATAN is the arctangent functions as would be understood by one skilled in the art.

At block 440, an operation may be performed on said stress image. In one or more embodiments, the operation may include sending a display signal to trigger displaying of said generated stress image or at least one IR frame of the received series of IR frames on a display 118 comprised in said thermal imaging device 110, in manners that would be understood by one skilled in the art. In one or more embodiments the operation may include sending a display signal to trigger displaying of a sequence of said generated stress images or IR frames of the received series of IR frames. In one or more embodiments, the operation may include sending captured IR images and/or the generated stress image as a signal frame of stress image data values to an external processor/processing unit 212 via a communication interface 116, in manners that would be understood by one skilled in the art. In one or more embodiments, the operation may include sending a sequence of said captured IR images and/or generated stress image as a signal frame of stress image data values to an external processor/processing unit 212 via a communication interface 116, in manners that would be understood by one skilled in the art. In one or more embodiments, the operation may include storing or recording captured IR images or said generated stress images in a memory. In one or more embodiments the sent captured IR images and/or the generated stress image are sent live or after retrieval from memory, wherein sending live comprises sending captured IR images substantially without delay from the time of capture or sending generated stress images substantially without delay from the time of generation.

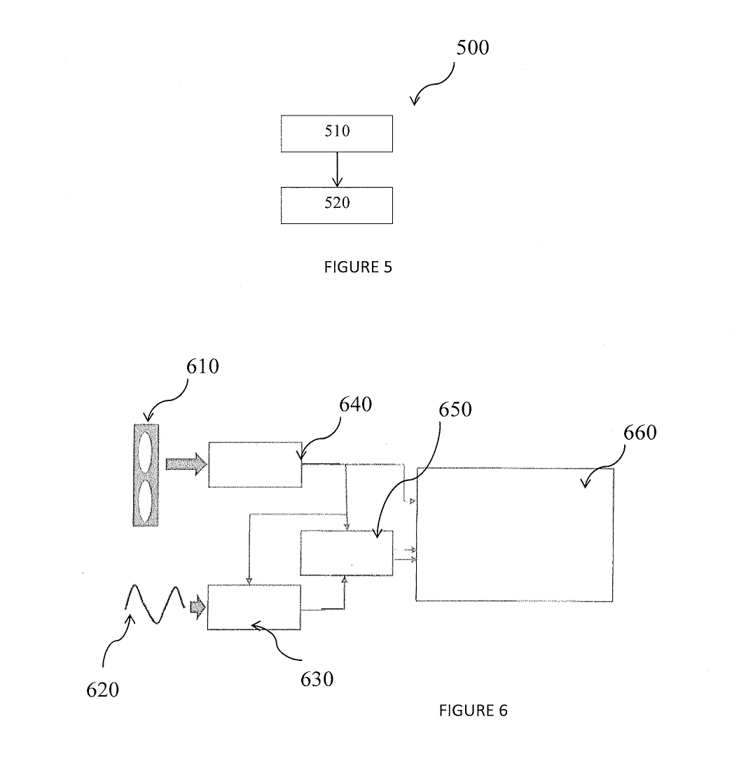

FIG. 5 shows a flowchart of a method 500 to display a stress image using a processor/processing unit comprised in a computing device, in accordance with an embodiment of the disclosure. For example, the method 500 may be performed using the processor/processing unit 212 comprised in the computing device 230 of FIG. 3. In general, one or more embodiments of method 500 may comprise various operations as follows. At block 510, a stress image as a signal frame of stress image data values may be received via a communication interface 216, e.g., from processor/processing unit 112. At block 520, a display signal may be sent to a display 218 to trigger displaying of said received stress image.

### Use Case Embodiments

In one example method of use according to an embodiment of the disclosure, a user of a handheld thermography, or IR, imaging device (e.g., thermal imaging device 110) aims the thermography, or IR, imaging device at an object in an observed real world scene to image the stress that the imaged object is subjected to. While aiming the thermal imaging device 110 at the observed real world scene, the user is typically presented with a stress image of the object in said observed real world scene on display 118 integrated in or coupled to the thermal imaging device 110. When a series of IR frames is captured, the image presentation will be updated after capturing of each frame or multiple frames in the series of IR frames, in real time or near real time.

In another example method of use according to an embodiment of the disclosure, a thermal, or IR, imaging device (e.g., thermal imaging device 110) is mounted at a fixed location with the purpose of monitoring an imaged scene over time, by capturing still pictures of the imaged scene at predetermined time intervals, or by capturing a continuous IR image frame sequence such as multiple consecutively captured IR images as a series of IR frames of the imaged and observed real world scene. The fixedly mounted thermography, or IR, imaging device may be coupled to a memory for storing the captured image frames or image frames sequence for later viewing and analysis by a user, and/or coupled to a display or presentation device for real-time or near real-time presentation of the captured image frames or image frame sequence to an user.

Another example method of use according to an embodiment of the disclosure is shown in FIG. 6. Multiple consecutive IR images depicting an object in an observed real-world scene are captured by infrared detector and driving electronics, in the form of an IR imaging system 640, as a series of IR frames during a time window. A lock-in signal 620 is simultaneously obtained, within the same time window, by a lock-in signal sampler 630. The lock-in signal sampler 630 may be in the form of a communications interface and/or a processor configured to perform image processing to extract the lock-in signal, depending on embodiments. A stress image based on the obtained lock-in signal and the received series of IR frames is generated by a processor comprised in a stress image generating unit in the form of a processor/processing unit 650. The captured IR images or the generated stress image may then be used to perform an operation. The operation may comprise, but is not limited to, displaying a captured IR image or said generated stress image on a display, storing captured IR images or said generated stress images to a memory, sending captured IR images or said generated stress images via said communications interface 630 to an external computing device for further operations such as displaying on a display of the external computing device, displaying a sequence of captured IR images or said generated stress images live or retrieved from a memory or any other operation in a thermal imaging device as would be understood by one skilled in the art.

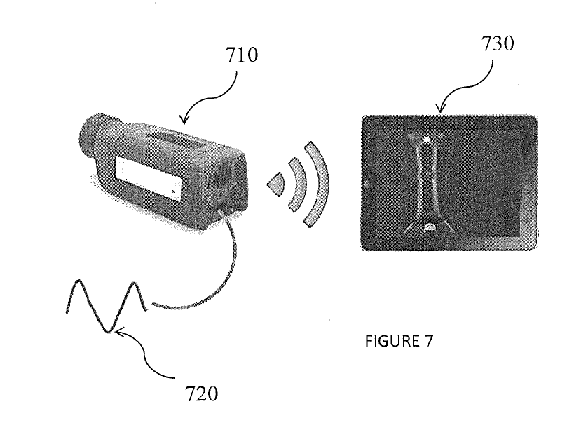

Another example method of use according to an embodiment of the disclosure is shown in FIG. 7. A lock-in signal 720 is received by a thermal imaging device 710 that, based on multiple consecutively captured IR images, generates a stress image and sends captured IR images or said generated stress images to an external computing device 730 for further operations such as displaying on a display of the external computing device.

### Further Embodiments

In one or more embodiments, a computer-readable medium may be provided which stores non-transitory information adapted to control a processor/processing unit to perform the various operations of the methods described herein.

In one or more embodiments, a computer program product may be provided which comprises code portions adapted to control a processor/processing unit to perform the various operations of the methods described herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Where applicable, the various hardware components and/or software components set forth herein can be combined into composite components comprising software, hardware, and/or both without departing from the spirit of the present disclosure. Also where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

While various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method comprising:
receiving multiple infrared (IR) images consecutively captured by a thermal imaging device as a series of IR frames, wherein the IR images are in a form of image data values representing infrared radiation emitted from an observed real world scene, and wherein the series of IR frames are received within a time window;
obtaining a lock-in signal corresponding to said time window;
generating, by a processor, a stress image based on the obtained lock-in signal and the received series of IR frames; and
performing an operation on said stress image.

2. The method of claim 1, wherein the performing the operation comprises sending a display signal to trigger displaying of said generated stress image or at least one IR frame from the received series of IR frames on a display comprised in said thermal imaging device.

3. The method of claim 1, wherein the performing the operation comprises sending the generated stress image as a signal frame of stress image data values to an external processor/processing unit via a communications interface of the thermal imaging device.

4. The method of claim 1, wherein the generating the stress image further comprises transforming the received series of IR frames to a frequency domain.

5. The method of claim 4, wherein the transforming the received series of IR frames to the frequency domain comprises performing a Fast Fourier Transform (FFT) on said received series of IR frames.

6. The method of claim 1, wherein:
the obtaining the lock-in signal further comprises obtaining phase information of said obtained lock-in signal; and
the generating the stress image is based on the phase information of said obtained lock-in signal and said received series of frames.

7. The method of claim 1, wherein the obtaining the lock-in signal comprises receiving said lock-in signal from an external source via a communications interface of the thermal imaging device.

8. The method of claim 1, wherein the obtaining said lock-in signal comprises performing image processing based on said received series of IR frames.

9. The method of claim 8, wherein the image processing comprises determining a reference IR image from said series of IR frames.

10. The method of claim 1, wherein said time window is defined as between the time of capturing the first IR image in said series of IR frames and the time of capturing the last IR image in said series of IR frames.

11. The method of claim 1, wherein the thermal imaging device comprises the processor, the method further comprising:
receiving, at a computing device, the stress image as a signal frame of stress image data values from the processor via a communications interface of the computing device; and
sending a display signal to a display of the computing device to trigger displaying of said received stress image.

12. A non-transitory computer-readable medium storing machine instructions which, when executed, causes a thermal imaging device to perform the method of claim 1.

13. A thermal imaging device, comprising:
an infrared (IR) imaging system configured to capture a series of IR images;
a processor configured to:
receive the series of IR images, wherein the IR images are in a form of image data values representing infrared radiation emitted from an observed real world scene, and wherein the series of IR images are received during a time window,
obtain a lock-in signal corresponding to said time window,
generate a stress image based on the obtained lock-in signal and the received series of IR images, and
perform an operation on said stress image;
at least one memory communicatively coupled to the processor and configured to store data values or parameters for the processor; and
a communications interface configured to send or receive signals representing data values or parameters to/from the processor from/to external units.

14. The thermal imaging device of claim 13, wherein the processor is configured to perform the operation on said stress image by sending a display signal to trigger displaying of said generated stress image or at least one IR image from the received series of IR images on a display comprised in said thermal imaging device.

15. The thermal imaging device of claim 13, wherein the processor is configured to generate the stress image by transforming the received series of IR images to a frequency domain.

16. The thermal imaging device of claim 15, wherein the processor is configured to transform the received series of IR frames to the frequency domain by performing a Fast Fourier Transform (FFT) on said received series of IR images.

17. The thermal imaging device of claim 13, wherein the processor is configured to:
obtain the lock-in signal by obtaining phase information of said obtained lock-in signal; and
generate the stress image based on the phase information of said obtained lock-in signal and said received series of frames.

18. The thermal imaging device of claim 13, wherein the processor is configured to obtain the lock-in signal by receiving said lock-in signal from an external source via the communications.

19. The thermal imaging device of claim 13, wherein the processor is configured to obtain said lock-in signal by performing image processing based on said received series of IR images to obtain a reference IR image from said series of IR images.

20. A system for generating and displaying a stress image, the system comprising:
a thermal imaging device configured to capture infrared (IR) images in a form of image data values representing IR radiation emitted from an observed real world scene and to generate a stress image based on a lock-in signal over a time window and a series of the IR images captured during the time window; and
a computing device comprising:
a display configured to receive a display signal and to display the received display signal as a displayed image,
a communications interface configured to send or receive data values or parameters from the thermal imaging device, and
a processor communicatively coupled to the display and the communications interface, the processor configured to:
receive the stress image as a signal frame of stress image data values from the thermal imaging device via the communications interface, and
send the display signal to the display to trigger displaying of said received stress image.
